(19) United States
(12) Patent Application Publication
(10) Pub. No.: US 2006/0041440 A1
(43) Pub. Date: Feb. 23, 2006

(54) Method, system and program product for managing a project

(75) Inventors: Li-Te Cheng, Malden, MA (US); Werner Geyer, Boston, MA (US); Susanne Hupfer, Lexington, MA (US); John F. Patterson, Carlisle, MA (US); Steven I. Ross, S. Hamilton, MA (US); Martin M. Wattenberg, Winchester, MA (US)

Correspondence Address: HOFFMAN, WARNICK & D'ALESSANDRO LLC, 75 STATE ST, 14TH, ALBANY, NY, 12207, US

(73) Assignee: International Business Machines Corporation, Armonk, NY (US)

(21) Appl. No.: 10/922,457

(22) Filed: Aug. 20, 2004

(51) Int. Cl. G06Q 99/00

(52) U.S. Cl. 705/1

(57) ABSTRACT

An improved solution for managing a project comprising one or more shared artifacts is described. In particular, an interactive event can be detected on a user system, and a notice of the interactive event can be generated. The notice can be provided to one or more other user systems that are currently accessing the project. A user interface at the other user system(s) can automatically surface information on the interactive event to a user.

### BACKGROUND OF THE INVENTION

1. Technical Field

The invention relates generally to managing a project. Specifically, under the present invention, a user system can generate an interactive event for an artifact for the project. A notice of the interactive event can be automatically provided to one or more other user systems working on the same project.

2. Background Art

Integrated Development Environments (IDEs), such as Websphere® Studio Application Developer offered by International Business Machines (IBM) Corp. of Armonk, N.Y., provide the primary workplace for completing a project, such as the development of a software product. To this extent, a typical IDE provides tools to manage and manipulate several types of artifacts for the project. For example, in software development, the artifacts can include models, source code files, function libraries, tasks, test cases, activities, etc.

Frequently, multiple users contribute to completing any given project. To this extent, each user may have a local copy of the various artifacts for the project that he/she can view, modify, etc. In this case, when a user has made changes to the local copy of an artifact that should be added to the project, the user can “check in” the artifact with the changes to a “master” copy of the artifact that is stored at a server or the like. Subsequently, other users can synchronize their local copy of the artifact with the master copy to obtain the most recent version of the artifact.

A problem can arise when two users make simultaneous modifications to the same artifact. In this case, there is a danger that a user that checks in his/her modified artifact may inadvertently overwrite a version of the artifact that included changes made by another user. To prevent this situation, various solutions can be used. For example, each user can be required to “check out” a particular artifact that he/she desires to modify. By allowing only one user the ability to check out each artifact, there is no danger of any other users checking in modifications that may conflict. However, many users find this solution too limiting as it severely limits the ability to work in parallel.

Another solution is to detect instances when overlapping modifications have been made to an artifact, and merge the modifications into a new version of the artifact. This solution works well when different portions of an artifact are modified, but may not work well when the modifications occur to the same portion of the artifact and/or one modification is not compatible with another modification. Additionally, neither of these solutions promote collaboration or coordination between multiple users while the modifications are being made.

As a result, a need exists for an improved solution for managing a project. In particular, a need exists for a management solution that can support and/or coordinate group problem solving involving shared artifacts. To this extent, a need exists for a method, system and program product that detect an interactive event that occurs on one user system and automatically provide information on the interactive event to another user system. In response, an appearance of an indicator for the artifact can be modified based on the interactive event to inform a user of the interactive event.

### SUMMARY OF THE INVENTION

The invention provides a solution in which a user can be notified of the occurrence of a remote interactive event. Specifically, under the present invention, a local interactive event for an artifact of a project can be captured. A notice can be generated, which includes information on the local interactive event. The notice can be sent to one or more other users that are working on the project. A user interface that the user(s) is using to work on the project can then automatically surface the interactive event based on the received notice. In one embodiment, an indicator for the corresponding artifact is altered based on the notice. As a result, a user can be automatically informed of the actions performed on artifact(s) by one or more other users. This information can be used to initiate collaboration between two or more users, avoid conflicting modifications among users, etc.

A first aspect of the invention provides a method of managing a project, the method comprising: storing a set of artifacts for the project; receiving a first notice of an interactive event for one of the set of artifacts from a first user system; and automatically providing a second notice to a second user system, wherein the second notice is based on the first notice.

A second aspect of the invention provides a method of managing a project, the method comprising: obtaining a set of artifacts for the project; generating a user interface for selecting at least one of the set of artifacts, wherein the user interface includes an indicator for each of the set of artifacts; receiving a notice of a remote interactive event for one of the set of artifacts; and altering the indicator for the one of the set of artifacts based on the notice.

A third aspect of the invention provides a system for managing a project, the system comprising: an artifact system for managing a set of artifacts for the project; an event system for receiving a first notice of an interactive event for one of the set of artifacts from a first user system; and a broadcast system for automatically providing a second notice to a second user system, wherein the second notice is based on the first notice.

A fourth aspect of the invention provides an integrated development environment (IDE) comprising: a selection system for generating a user interface for selecting at least one of the set of artifacts, wherein the user interface includes an indicator for the at least one of the set of artifacts; an editor system for displaying at least one of the set of artifacts for a project; and an indicator system for altering the indicator based on a notice of a remote interactive event for the at least one of the set of artifacts.

A fifth aspect of the invention provides a program product stored on a recordable medium for managing a project, which when executed comprises: program code for obtaining a set of artifacts for the project; program code for generating a user interface for selecting at least one of the set of artifacts, wherein the user interface includes an indicator for at least one of the set of artifacts; program code for receiving a notice of a remote interactive event for one of the set of artifacts; and program code for altering the indicator for the one of the set of artifacts based on the notice.

A sixth aspect of the invention provides a system for deploying an application for managing a project, the system comprising: a computer infrastructure being operable to: manage a set of artifacts for the project; receive a first notice of an interactive event for one of the set of artifacts from a first user system; and automatically provide a second notice to a second user system, wherein the second notice is based on the first notice.

A seventh aspect of the invention provides computer software embodied in a propagated signal for managing a project, the computer software comprising instructions to cause a computer system to perform the following functions: manage a set of artifacts for the project; receive a notice of an interactive event for one of the set of artifacts from a first user system; and automatically provide the notice to a second user system.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for managing a project according to one embodiment of the invention;

FIG. 2 shows illustrative method steps for processing a local interactive event;

FIG. 3 shows illustrative method steps for processing a notice of an interactive event at a server;

FIG. 4 shows illustrative method steps for processing a notice of a remote interactive event;

FIG. 5 shows an illustrative interface for working on a project;

FIG. 6 shows the interface of FIG. 5 after a user event; and

FIG. 7 shows the interface of FIG. 5 after another user event.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution in which a user can be notified of the occurrence of a remote interactive event. Specifically, under the present invention, a local interactive event for an artifact of a project can be captured. A notice can be generated, which includes information on the local interactive event. The notice can be sent to one or more other users that are working on the project. A user interface that the user(s) is using to work on the project can then automatically surface the interactive event based on the received notice. In one embodiment, an indicator for the corresponding artifact is altered based on the notice. As a result, a user can be automatically informed of the actions performed on artifact(s) by one or more other users. This information can be used to initiate collaboration between two or more users, avoid conflicting modifications among users, etc. It is understood that, as used herein, the term “remote” means that the corresponding individual, interactive event, etc. is not using, did not occur on, etc., the same computer system. To this extent, remote does not imply any physical separation. For example, two users could sit next to each other in an office, but be remote from each other when each uses his/her own computer system.

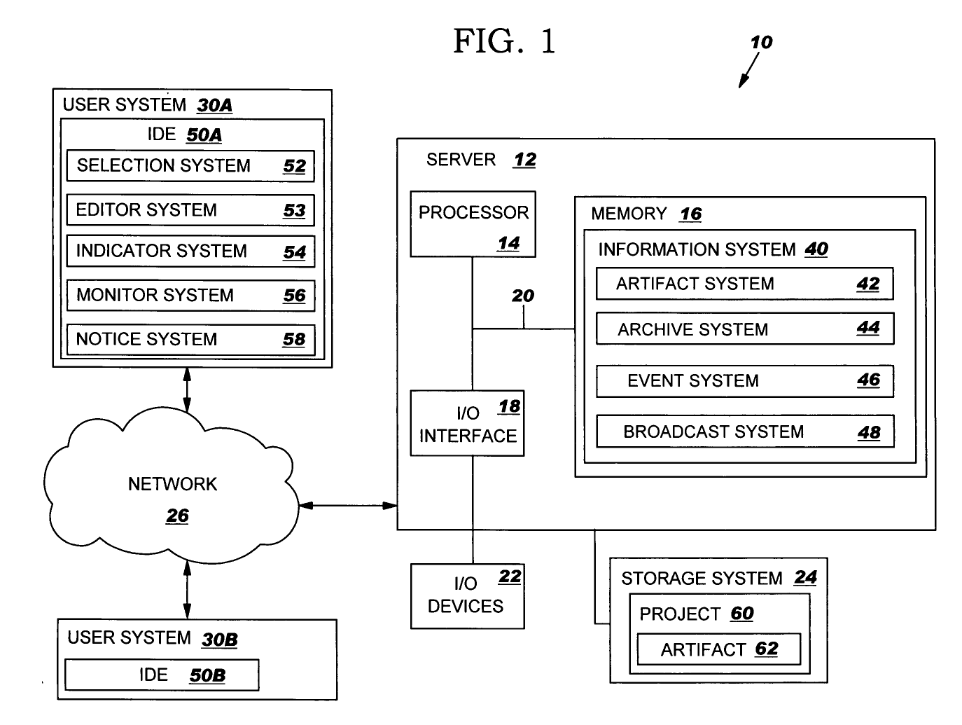

Turning to the drawings, FIG. 1 shows an illustrative system 10 for managing a project 60. In general, one or more users (not shown) can use user systems 30A-B to work on/develop project 60. For example, each user system 30A-B can include an integrated development environment (IDE) 50A-B that allows the corresponding users to manage various data related to project 60. To this extent, each IDE 50A-B can communicate with information system 40 to provide and/or receive data regarding project 60. It is understood that project 60 can comprise any data (e.g., artifact 62) and/or resource that is shared by a group (e.g., two or more) of users. In particular, the group of users will cooperate to solve problems, and/or create, develop, and/or manage project 60 to complete a goal. For example, project 60 can comprise computer program code developed for a software product, computer aided design (CAD) drawing files for a structure or computing device, etc. Further, project 60 can comprise data for planning, scheduling, designing, documenting, etc., the goal(s) for project 60.

When developing project 60, user systems 30A-B communicate with server 12 and/or another user system 30A-B over one or more networks 26. Each network 26 can comprise any type of communications link. For example, network 26 can comprise an addressable connection in a client-server (or server-server) environment that may utilize any combination of wireline and/or wireless transmission methods. To this extent, server 12 and user systems 30A-B may utilize conventional network connectivity, such as Token Ring, Ethernet, WiFi or other conventional communications standards. Further, network 26 can comprise any combination of various types of networks, including the Internet, a wide area network (WAN), a local area network (LAN), a virtual private network (VPN), etc. Where user systems 30A-B communicate with server 12 via the Internet, connectivity could be provided by conventional TCP/IP sockets-based protocol, and user systems 30A-B could utilize an Internet service provider to establish connectivity to server 12.

In any event, server 12 and user systems 30A-B comprise any type of computing devices capable of communicating with one or more other computing devices and/or interacting with one or more users. For example, server 12 and/or user systems 30A-B can each comprise a server, a desktop computer, a laptop, a handheld device, a mobile phone, a pager, a personal data assistant, etc. To this extent, server 12 is shown including a processor 14, a memory 16, an input/output (I/O) interface 18, a bus 20, external I/O devices/resources 22, and a storage system 24. In general, processor 14 executes computer program code such as information system 40, that is stored in memory 16 and/or storage system 24. While executing computer program code (e.g., information system 40), processor 14 can read and/or write data to/from memory 16, storage system 24, and/or I/O interface 18. Bus 20 provides a communication link between each of the components in server 12.

It is understood that server 12 is only illustrative of various possible combinations of hardware. For example, processor 14 may comprise a single processing unit, or be distributed across one or more processing units in one or more locations, e.g., on a client and server. Similarly, memory 16 and/or storage system 24 can comprise any combination of various types of data storage and/or transmission media that reside at one or more physical locations. I/O interface 18 can comprise any system for exchanging information with one or more I/O devices 22 that can provide an interface with one or more other computing devices (e.g., user systems 30A-B) and/or users. It is understood, however, that if server 12 comprises a handheld device or the like, one or more I/O devices 22 (e.g., a display) could be contained within server 12, and not as an external I/O device 22 as shown. Further, it is understood that user systems 30A-B typically include similar elements (e.g., processor, memory, I/O interface, etc.) as shown for server 12. These have not been separately shown and described for brevity.

In order to manage project 60, information system 40 is shown including an artifact system 42 for managing a set of artifacts 62 for project 60, and an archive system 44 for archiving various versions of the set of artifacts 62. Information system 40 is also shown including an event system 46 for receiving a notice of an interactive event for an artifact 62, and a broadcast system 48 for automatically providing the notice to one or more user systems 30A-B. In general, information system 40 can provide and/or receive data relating to project 60 to/from one or more IDEs 50A-B. Each IDE 50A-B can comprise computer program code that executes on a user system 30A-B to generate a user interface that enables a user to work on project 60. To this extent, IDE 50A is shown including a selection system 52 that generates a user interface for selecting one or more artifacts 62, and an editor system 53 that generates a user interface that enables a user to view, modify, etc., a particular artifact 62. Further, IDE 50A is shown including an indicator system 54 for altering a selection indicator based on the notice, a monitor system 56 for detecting a local interactive event, and a notice system 58 for generating a notice based on the local interactive event. Operation of each of these systems is discussed further below.

It is understood that, while not shown for brevity, IDE 50B can include each of the systems shown as part of IDE 50A. However, it is understood that information system 40 and IDEs 50A-B are only illustrative. As a result, some of the systems and/or functionality shown in information system 40 and IDE 50A may be implemented together, may not be implemented, and/or may be implemented separately. Further, additional systems and/or functionality may be included in information system 40 and/or IDEs 50A-B.

For example, information system 40 could include the functionality shown and described for IDEs 50A-B, and users could access information system 40 in a client-server environment. Similarly, each IDE 50A-B could comprise similar systems as shown and described for information system 40, and user systems 30A-B could communicate over a peer-to-peer network configuration to replicate locally stored copies of project 60 without the use of server 12 and/or storage system 24. Additionally, event system 44 and/or broadcast system 46 could be implemented apart from information system 40 on another computer that is dedicated to managing notices of interactive events but does not include any artifact 62 support capabilities.

As previously noted, the invention provides an improved solution for managing project 60. In one embodiment, a set (one or more) of artifacts 62 for project 60 can be stored on storage system 24. In this case, artifact system 42 can be used to manage set of artifacts 62. In particular, artifact system 42 can add/remove an artifact 62 to/from project 60, provide a copy of one or more artifacts 62 to user systems 30A-B, etc. Further, artifact system 42 can receive a modified artifact 62 from a user system 30A-B. In this case, artifact system 42 can provide the modified artifact 62 to archive system 44. Archive system 44 can archive both the modified version and each previous version of artifact 62. As a result, modifications to each artifact 62 can be viewed, tracked, reversed, etc., by a user as desired.

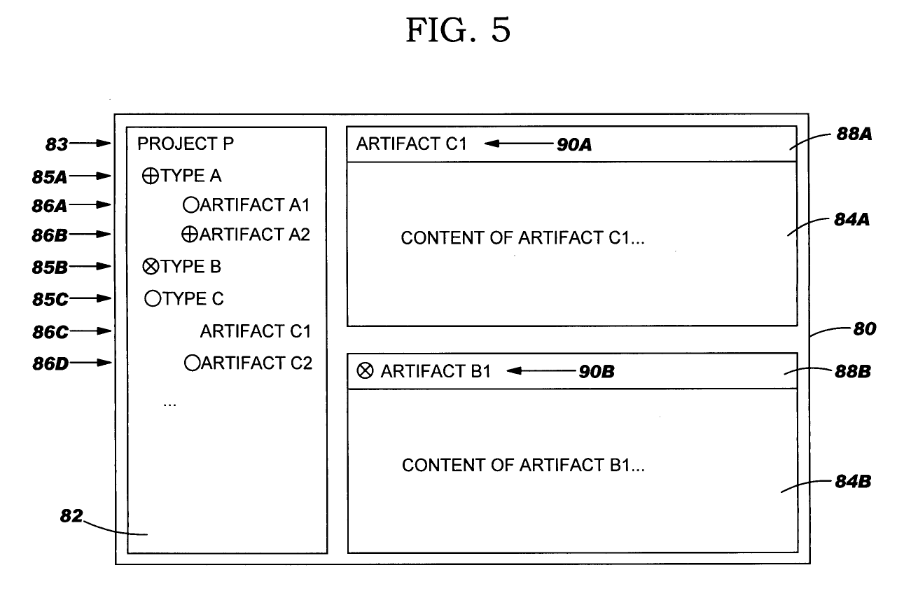

Each user uses an IDE such as IDE 50A to work on project 60. In particular, IDE 50A can generate a user interface at user system 30A that enables a user to select project 60 for viewing/editing. Once project 60 has been selected, selection system 52 can generate a user interface at user system 30A for displaying a listing of some/all of the set of artifacts 62 that belong to project 60. For example, FIG. 5 shows an illustrative user interface 80 that can be generated by IDE 50A. User interface 80 is shown including a second user interface 82 that is generated by selection system 52. Second user interface 82 can include an indicator 86A-D for each artifact 62 (FIG. 1) that belongs to project 60 (FIG. 1). For example, indicators 86A-D can comprise a name of each artifact 62. However, it is understood that only a portion of indicators 86A-D may be displayed in user interface 82 at any given time.

In one embodiment, user interface 82 comprises a tree structure for displaying indicators 86A-D. For example, a top node 83 can be generated for the selected project 60 (FIG. 1), e.g., PROJECT P. Project 60 may comprise artifacts 62 (FIG. 1) that have various types (e.g., models, source code files, classes, function libraries, tasks, test cases, activities, etc.). In this case, top node 83 can comprise a parent node for a type node 85A-C for each type of artifact 62 for project 60 (e.g., TYPE A, TYPE B, TYPE C, etc.). Further, each type node 85A-C can comprise a parent node for zero or more indicators 86A-D that correspond to artifacts 62 for project 60 (e.g., ARTIFACT A1, ARTIFACT A2 for TYPE A). As a result, the illustrative tree structure would comprise three levels (e.g., project, type, indicator). However, it is understood that any number of levels and groupings of indicators 86A-D are possible.

In any event, user interface 82 can enable a user to select any one of the set of artifacts 62 (FIG. 1) that belong to a particular project 60 (FIG. 1) that he/she desires to view and/or modify by selecting the corresponding indicator 86A-D. In response, selection system 52 (FIG. 1) can launch an appropriate tool in editor system 53 (FIG. 1) for displaying the content of the selected artifact 62. For example, user interface 80 is further shown including editor interfaces 84A-B. Each editor interface 84A-B displays content of the corresponding artifact 62 (e.g., ARTIFACT C1 and ARTIFACT B1, respectively). To this extent, editor system 53 can comprise each tool necessary for displaying and/or editing various types of artifacts 62 such as a text editor, a drawing program, a database manager, planning software, etc. For example, when artifact 62 comprises a source code file, a text editor in editor system 53 can be used to display and/or modify the source code file.

Further, each editor interface 84A-B is shown including a identification area 88A-B that comprises an indicator 90A-B for the corresponding artifact 62 being displayed by the respective editor interface 84A-B. It is understood that identification area 88A-B can comprise any location and/or shape. For example, identification area 88A-B could comprise a tab shape, or the like. As shown, user interface 82 and editor interfaces 84A-B can each comprise a child interface (e.g., window) of interface 80. In this case, each child interface will occupy a portion of the display area of interface 80. However, it is understood that this arrangement is only illustrative, and various alternatives are possible. Additional aspects of the invention shown in FIG. 5 will be discussed below.

Returning to FIG. 1, in general, the invention provides a solution for managing project 60 in which one or more users can be automatically notified of a remote interactive event. An interactive event can comprise any type of activity that may occur on artifact 62 in which a remote user may be interested. To this extent, typical interactive events can comprise various operations that can be performed on artifact 62 by a user. For example, an interactive event can comprise an artifact open event that occurs when a user opens artifact 62, an artifact close event that occurs when a user closes artifact 62, an artifact save event that occurs when a user saves a modification to a remote copy of artifact 62, and the like. Each of these interactive events provides some indication of what action(s) are being performed on various artifacts 62 for project 60. With this information, another user may desire to discuss some aspect of artifact 62 with the user that is currently working on/viewing artifact 62. In this manner, the invention can promote collaboration between multiple users working on project 60.

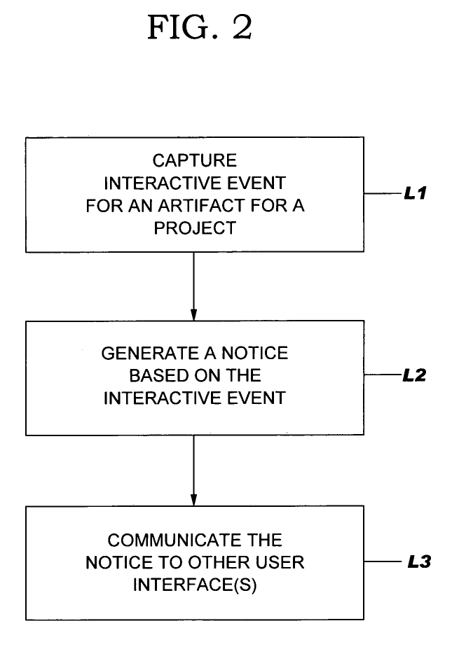

Further details will be discussed with reference to FIGS. 1 and 2. FIG. 2 shows illustrative method steps that can occur on, for example, user system 30A when an interactive event occurs. In step L1, monitor system 56 can capture a local interactive event that occurs on user system 30A. For example, monitor system 56 can monitor actions performed by IDE 50A, selection system 52, and/or editor system 53 by monitoring various messages generated between the various systems and/or between the various systems and an operating system operating on user system 30A. In this case, an interactive event is captured when one or more messages that define the interactive event are detected. In any event, when an interactive event is captured, monitor system 56 can provide information on the interactive event to notice system 58.

In step L2, notice system 58 can generate a notice based on the interactive event. The notice can comprise data regarding the interactive event. For example, the notice can include a timestamp for the occurrence of the interactive event, an identity of the user and/or user system 30A that generated the interactive event, data that identifies the interactive event, data that identifies artifact 62, and the like. After the notice has been generated, in step L3, notice system 58 can communicate the notice to one or more other user systems, e.g., user system 30B.

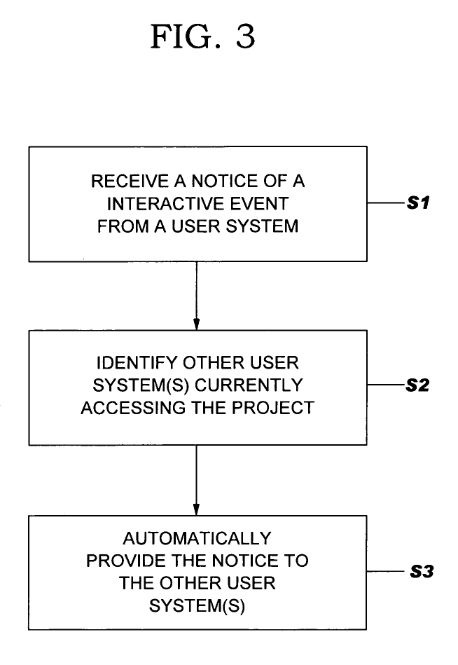

Depending on an architecture of network 26, various solutions exist for communicating the notice to user system 30B. For example, in a peer-to-peer network, the message may be communicated directly from user system 30A to user system 30B. However, server 12 may be utilized to communicate notices between various user systems 30A-B. In one embodiment, discussed with reference to FIGS. 1 and 3, in step S1 of FIG. 3, event system 46 receives the notice of the interactive event from user system 30A. Event system 46 can format and/or add information to the notice. For example event system 46 could add a timestamp, an identifier for user system 30A, and the like, rather than notice system 58 of IDE 50A.

Further, event system 46 could capture one or more interactive events. For example, as discussed above, a user may check in a new version of artifact 62 using archive system 44. In this case, the request/creation of a new archived version of artifact 62 can comprise an interactive event, and event system 46 can capture its occurrence. To this extent, event system 46 could generate the notice based on the interactive event. Regardless, event system 46 will forward each notice to broadcast system 48 for further processing.

In step S2, broadcast system 48 can identify other user systems 30A-B currently accessing project 60. This can be done using any solution. For example, when IDE 50A-B opens project 60, selection system 52 can send a message to broadcast system 48 that indicates that the corresponding user system 30A-B is currently accessing project 60. A similar message can be sent by selection system 52 when project 60 is closed to indicate that project 60 is no longer being accessed. In any event, broadcast system 48 can maintain a list of user systems 30A-B that are currently accessing project 60. Alternatively, broadcast system 48 can maintain a list of user systems 30A-B that may access project 60 regardless of whether the user systems 30A-B are currently being used to access project 60.

In step S3, broadcast system 48 automatically provides the notice to one or more user systems 30B. Alternatively, broadcast system 48 could generate a second notice based on the first notice, and provide the second notice to one or more user systems 30B. In either case, broadcast system 48 can communicate the notice to all user systems 30A-B that are currently accessing project 60, individually communicate the notice to each user system 30B that is remote from user system 30A on which the interactive event occurred, communicate the notice to all user systems 30A-B on network 26 regardless of any access to project 60, etc.

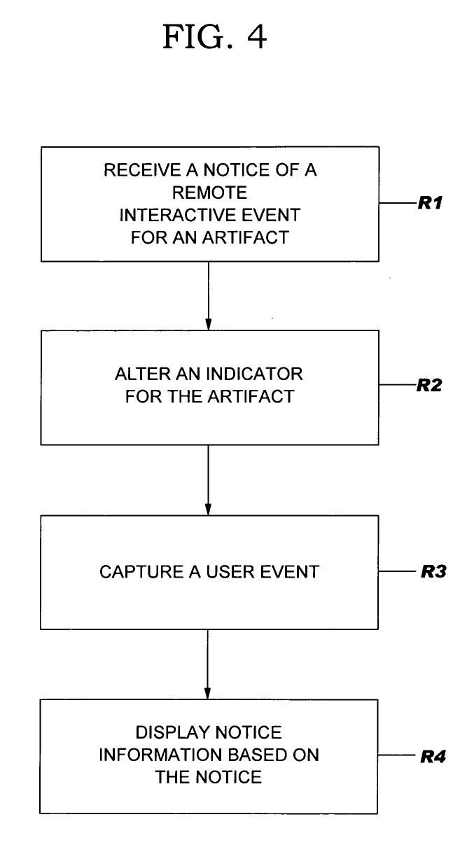

In any event, user system 30B will receive the notice. Referring now to FIGS. 1 and 4, in step R1, the notice of the remote interactive event is received by IDE 50B. For example, a communication system executing on user system 30B can receive the notice and forward it to IDE 50B. In step R2, indicator system 54 can alter an indicator for the artifact for which the interactive event occurred. To this extent, the indicator can be altered based on the interactive event.

As shown in FIG. 5, indicators 86A-D, 90A-B can have various markings adjacent to the artifact name. Each marking can indicate a different interactive event. For example, no markings for indicators 86C, 90A may indicate that no remote user is currently accessing the corresponding artifact 62 (FIG. 1). In this case, the fact that the corresponding artifact 62 is being accessed locally, does not alter indicators 86C, 90A. Further, a circle marking for indicators 86A, 86D may indicate that the corresponding artifact 62 is being viewed by at least one remote user, the circle with a plus marking shown for indicator 86B may indicate that at least one remote user has saved a modification to the corresponding artifact 62, and the circle with an X shown for indicator 90B may indicate that at least one remote user has checked in a new version of the corresponding artifact 62.

Selection of the markings for display in each indicator 86A-D, 90A-B, can be performed based on a priority of the corresponding interactive event(s). For example, when one remote user is viewing an artifact 62 (FIG. 1), while another remote user has modified the same artifact 62, the marking for the modification can be displayed. Similarly, the marking for a newly checked in version can be displayed over either the modification and/or viewing markings. To this extent, when user interface 82 comprises a tree structure, a marking can also be altered for the parent node of an artifact 62. In one embodiment, the parent node can comprise the marking that corresponds to the highest priority interactive event that has occurred for the child artifacts 62. For example, type node 85A is shown having the modified marking based on ARTIFACT A2, type node 85B is shown having the new version marking based on ARTIFACT B1, and type node 85C is shown having the viewing marking based on ARTIFACT C2.

As each user opens project 60 (FIG. 1) using user interface 80, it is desirable to update indicators 86A-D, 90A-B and/or type nodes 85A-C to reflect the current status of the corresponding artifacts 62 (FIG. 1). Returning to FIG. 1, once a user has opened project 60 using selection system 52, indicator system 54 can request the current status of the corresponding artifacts 62. For example, indicator system 54 could obtain the current status of each artifact 62 from event system 46. To this extent, event system 46 can maintain a history of interactive events for each artifact 62 so that the current status can be provided to indicator system 54 when project 60 is initially opened. It is understood that various alternatives are possible, for example, indicator system 54 could determine the existence of a new archived version from archive system 44, determine local modification/viewing statuses from each remote user system 30B, etc.

While FIG. 5 shows the use of markings in indicators 86A-D, 90A-B and/or type nodes 85A-C to show the interactive status of a corresponding artifact 62 based on the occurrence of one or more interactive events, additional information about the interactive status of a particular artifact 62 may be desired by a user. For example, as noted above, each notice can include additional data such as user information, timestamp, etc. To this extent, again referring to FIGS. 1 and 4, in step R3 of FIG. 4, indicator system 54 can capture a user event at user system 30B. The user event can comprise any action performed by the user to selectively display additional information on one or more interactive events. For example, the user may select from a menu, right click in a particular location of a display, hover a pointing device in a particular location, etc. Regardless, in step R4, indicator system 54 can display notice information based on previously received notice(s) in response to the user event.

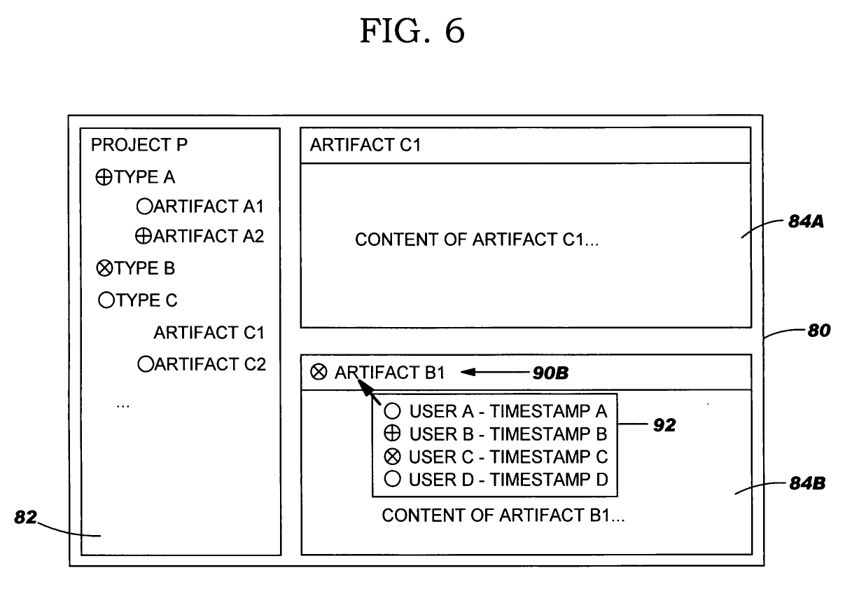

The notice information can be displayed using any solution. For example, FIG. 6 shows an illustrative popup window 92 that indicator system 54 (FIG. 1) can generate in response to a hover event, right click, or the like, over indicator 90B. In particular window 92 is shown including information on a plurality of interactive events, such as users and their corresponding statuses with respect to ARTIFACT B 1. As shown, additional data such as a timestamp that indicates when the corresponding interactive event occurred can be included for each user.

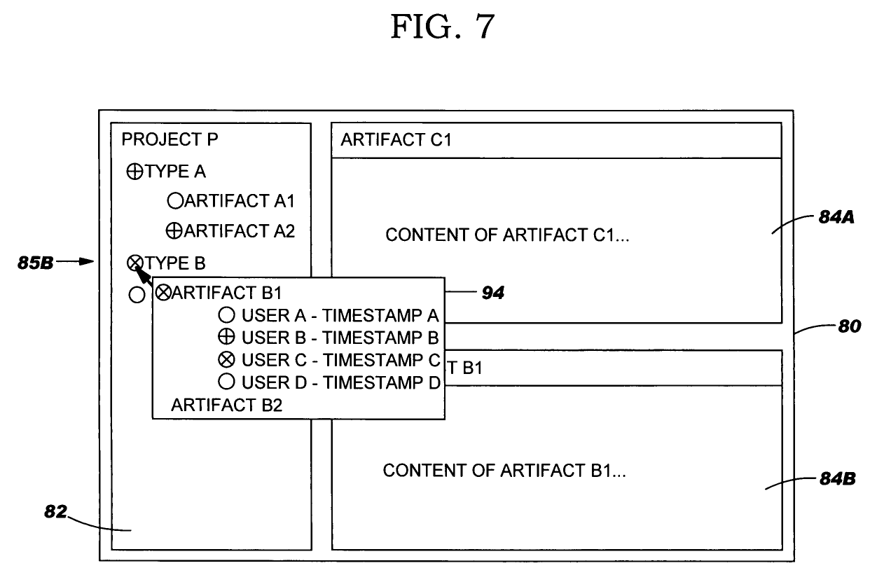

Similarly, as shown in FIG. 7, indicator system 54 (FIG. 1) can generate a similar popup window 94 in response to a user event for type node 85B. In this case, popup window 94 can display information on the interactive status for each of the various child artifacts 62 (FIG. 1) of type node 85B (e.g., ARTIFACT B1, ARTIFACT B2). Further, popup window 94 can comprise information on zero or more interactive events that have occurred for each artifact 62, such as the user and his/her corresponding status with respect to each artifact 62. As shown, this information can be displayed in a tree structure in popup window 94 similar to the tree structure of user interface 82.

It is understood that the various markings, indicators 85A-C, 86A-D, 90A-B (FIG. 5), and interactive events are only illustrative. To this extent, any combination of markings, shapes, colors, text, fonts/styles, etc., can be used to represent any type of interactive event. For example, indicators 85A-C, 86A-B, 90A-B can have a background color, text color, and/or font/style (e.g., bold, italics, point size, etc.) changed based on a particular interactive event. Further, it is understood that popup windows 92 (FIG. 6) and 94 (FIG. 7) are only illustrative. For example, an abbreviated text summary could be included in identification area 88B (FIG. 5) to the right of indicator 90B, rather than in popup window 92. In this case, the text summary can comprise a different font/style than that of indicator 90B to assist in differentiating the information.

In addition to modifying an indicator, indicator system 54 (FIG. 1) can generate other types of notifications. For example, a user may desire to know when a new version of a particular artifact 62 (FIG. 1) has been checked in by another user. In this case, the user can indicate that indicator system 54 should generate a popup message, a sound, or the like, when this event occurs. Subsequently, when indicator system 54 receives a notice that indicates that the new version of artifact 62 has been checked in, indicator system can generate the desired notification.

It should be appreciated that the teachings of the present invention could be offered as a business method on a subscription or fee basis. For example, information system 40 (FIG. 1) could be created, maintained, supported, and/or deployed by a service provider that offers the functions described herein for customers. That is, a service provider could offer to manage project 60 (FIG. 1) as described above. It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention also can be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims. For example, while the invention has primarily been shown and described in conjunction with an IDE 50A-B (FIG. 1), it is understood that the teachings of the invention can be readily applied to other types of cooperative problem solving tools.

What is claimed is:

1. A method of managing a project, the method comprising:
storing a set of artifacts for the project;
receiving a first notice of an interactive event for one of the set of artifacts from a first user system; and
automatically providing a second notice to a second user system, wherein the second notice is based on the first notice.

2. The method of claim 1, further comprising:
generating a user interface at the second user system for selecting at least one of the set of artifacts, wherein the user interface includes an indicator for the one of the set of artifacts;
receiving the second notice at the second user system; and
altering the indicator based on the second notice.

3. The method of claim 2, further comprising:
capturing a user event at the second user system; and
displaying notice information based on the second notice in response to the user event.

4. The method of claim 1, further comprising:
capturing the interactive event at the first user system; and
generating the first notice based on the interactive event.

5. The method of claim 1, wherein the interactive event comprises one of an artifact open event, an artifact close event, and an artifact save event.

6. The method of claim 1, further comprising providing a copy of the set of artifacts to a plurality of user systems.

7. The method of claim 1, further comprising archiving a plurality of versions of at least one of the set of artifacts.

8. The method of claim 7, wherein the interactive event comprises a new archived version of one of the set of artifacts.

9. A method of managing a project, the method comprising:
obtaining a set of artifacts for the project;
generating a user interface for selecting at least one of the set of artifacts, wherein the user interface includes an indicator for each of the set of artifacts;
receiving a notice of a remote interactive event for one of the set of artifacts; and
altering the indicator for the one of the set of artifacts based on the notice.

10. The method of claim 9, further comprising:
capturing a user event; and
displaying notice information based on the notice in response to the user event.

11. The method of claim 9, further comprising:
capturing a local interactive event for one of the set of artifacts;
generating a second notice based on the local interactive event; and
communicating the second notice to at least one additional user interface.

12. The method of claim 11, wherein the communicating step includes:
receiving the second notice at a server; and
automatically providing the second notice to the at least one additional user interface.

13. The method of claim 9, wherein the user interface comprises a tree structure.

14. The method of claim 13, further comprising altering a parent node of an indicator for the one of the set of artifacts in the tree structure based on the notice.

15. A system for managing a project, the system comprising:
an artifact system for managing a set of artifacts for the project;
an event system for receiving a first notice of an interactive event for one of the set of artifacts from a first user system; and
a broadcast system for automatically providing a second notice to a second user system, wherein the second notice is based on the first notice.

16. The system of claim 15, further comprising an archive system for archiving a plurality of versions of at least one of the set of artifacts.

17. The system of claim 15, further comprising an integrated development environment (IDE) for generating a user interface at the second user system.

18. The system of claim 15, further comprising a selection system for generating a user interface for selecting at least one of the set of artifacts, wherein the user interface includes an indicator for the one of the set of artifacts.

19. The system of claim 18, further comprising an indicator system for altering the indicator based on the second notice.

20. The system of claim 15, further comprising a notice system for generating the first notice.

21. The system of claim 15, further comprising a monitor system for capturing the interactive event.

22. An integrated development environment (IDE) comprising:
a selection system for generating a user interface for selecting at least one of the set of artifacts, wherein the user interface includes an indicator for the at least one of the set of artifacts;
an editor system for displaying at least one of the set of artifacts for a project; and
an indicator system for altering the indicator based on a notice of a remote interactive event for the at least one of the set of artifacts.

23. The IDE of claim 22, further comprising a monitor system for capturing a local interactive event for one of the set of artifacts.

24. The IDE of claim 23, further comprising a notice system for generating another notice based on the local interactive event.

25. A program product stored on a recordable medium for managing a project, which when executed comprises:
program code for obtaining a set of artifacts for the project;
program code for generating a user interface for selecting at least one of the set of artifacts, wherein the user interface includes an indicator for at least one of the set of artifacts;
program code for receiving a notice of a remote interactive event for one of the set of artifacts; and
program code for altering the indicator for the one of the set of artifacts based on the notice.

26. The program product of claim 25, further comprising:
program code for capturing a user event; and
program code for displaying notice information based on the notice in response to the user event.

27. The program product of claim 25, further comprising:
program code for capturing a local interactive event for one of the set of artifacts;
program code for generating a second notice based on the local interactive event; and
program code for communicating the second notice to at least one additional user interface.

28. A system for deploying an application for managing a project, the system comprising:
a computer infrastructure being operable to:
manage a set of artifacts for the project;
receive a first notice of an interactive event for one of the set of artifacts from a first user system; and
automatically provide a second notice to a second user system, wherein the second notice is based on the first notice.

29. The system of claim 15, wherein the computer infrastructure is further operable to archive a plurality of versions of at least one of the set of artifacts.

30. Computer software embodied in a propagated signal for managing a project, the computer software comprising instructions to cause a computer system to perform the following functions:
manage a set of artifacts for the project;
receive a notice of an interactive event for one of the set of artifacts from a first user system; and
automatically provide the notice to a second user system.

31. The computer software of claim 30, further comprising instructions to archive a plurality of versions of at least one of the set of artifacts.
